(19) United States
(12) Patent Application Publication
(10) Pub. No.: US 2011/0035768 A1
(43) Pub. Date: Feb. 10, 2011

(54) Method and Arrangements for Control of Consumption of Content Services

(75) Inventors: Robbie Ling, Shanghai (CN); Emer Chen, Shanghai (CN); Stefan Ekenberg, Lund (SE); Liang Feng Hu, Shanghai (CN); Jinyang Xie, Shanghai (CN)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/851,683

(22) Filed: Aug. 6, 2010

Related U.S. Application Data
(60) Provisional application No. 61/232,093, filed on Aug. 7, 2009.
(60) Provisional application No. 61/233,606, filed on Aug. 13, 2009.

(30) Foreign Application Priority Data
Jun. 9, 2010 (SE) PCT/SE2010/050640

(51) Int. Cl. H04N 7/16

(52) U.S. Cl. 725/28

(57) ABSTRACT

The present invention relates to a server and a client for providing parental control of media content and methods thereof. In order to achieve a more flexible service deployment of the parental control, the parental control is implemented in the service consumption period according to the present invention. The operator can then offer content services which do not require a specific service order.

The server sends a message to the client indicating that a parental control verification code is required in response to a request of a content during the consumption phase. A parental control verification code such as a PIN code is then inserted in a field in an authentication field originally intended for a password for authenticating the user. Thereby, parental control can be achieved even if a specific service order is not performed.

### RELATED APPLICATIONS

This application claims priority from U.S. Provisional Application No. 61/232,093 filed Aug. 7, 2009; U.S. Provisional Application No. 61/233,606 filed Aug. 13, 2009; and International Application No. PCT/SE2010/050640 filed Jun. 9, 2010, the contents of which are incorporated herein by reference in their entirety.

### TECHNICAL FIELD

The present invention relates generally to methods and arrangements for control of consumption of content services, i.e. of user's access to the content services, e.g. Mobile TV services.

### BACKGROUND

One type of control of a user's access to content services is referred to as parental control. Parental control provides parents with automated tools to control which content and services their children are allowed to have access to. Typically, this is an optional feature e.g. included in digital television services, computer and video games, mobile phones and computer software.

Usually, parental control can be implemented by using functionalities which can be divided into three categories:

1. Content filters, which limit access to age-appropriate content, content intended for a specific device or intended for a specific user group etc;
2. Usage control, which constrains the usage of certain contents by placing time-limits on usage or forbidding certain types of usage;
3. Monitoring usage to track location and activity of the content.

Parental control is very useful for mobile TV, as some contents might be harmful to children. The children will be allowed to access certain content only if they get approval from their parents.

An example how parental control has been implemented by using SMS (Short Message Service) approval within the mobile TV area is described in WO 2010019095.

When a child is going to purchase content which requires parental approval, a short message will be sent out to his/her parents. Unless the youth receives SMS approval from his/her their parents, he/she is not able to purchase those contents.

In the prior art solutions, the parental control is performed in connection with the service order procedure (i.e., purchase period). Thus in order to be able to limit access to some content, a service order has to be performed. However, content providers may also provide contents which require access control without the need of service ordering. Also, it may be inconvenient and inflexible to a user to have to perform a service order before being able to consume the content.

### SUMMARY

Teachings herein advantageously achieve a more flexible service deployment of parental control. In particular, the parental control is implemented in the service consumption period. The operator can then offer content services which do not require a specific service order.

The server sends a message to the client indicating that a parental control verification code is required in response to a request of a content during the consumption phase. A parental control verification code such as a PIN code is then inserted in a field in an authentication field originally intended for a password for authenticating the user. Thereby, parental control can be achieved even if a specific service order is not performed.

According to a first aspect of the present invention a method in a server for controlling content to be consumed by a user having a granted user specific parental rating level and the controlled content is associated with a content specific parental rating level is provided. In the method, the server receives a request for consuming a certain content associated with a content specific parental rating level from a client used by a user, then the server checks if the requested content is associated with a content specific parental rating level that is more restrictive than a user specific parental level granted for the user. If the requested content is associated with a content specific parental rating level that is more restrictive than the user specific parental level granted for the user, the server sends a message indicating that a parental control verification code is required and receives a parental control verification code in a message comprising authorization information wherein the parental control verification code is inserted instead of a password in the message. Finally, the parental control verification code is verified.

According to a second aspect of the present invention a method in a client for allowing a user of the client to get access to content protected by parental control is provided. The user has a granted user specific parental rating level and the protected content is associated with a content specific parental rating level. In the method, the client sends a request for consuming a certain content associated with a content specific parental rating level to a content server. If the requested content is associated with a content specific parental rating level that is more restrictive than a user specific parental level granted for the user then the client receives a message indicating that a parental control verification code is required. The client prompts the user to enter the parental control verification code and receives the parental control verification code. Further, the client sends the parental control verification code in a message comprising authorization information wherein the parental control verification code is inserted instead of a password in the message.

According to a third aspect of the present invention a server for controlling content to be consumed by a user having a granted user specific parental rating level and the controlled content is associated with a content specific parental rating level is provided. The server comprises a receiver configured to receive a request for consuming a certain content associated with a content specific parental rating level from a client used by a user, a processor configured to check if the requested content is associated with a content specific parental rating level that is more restrictive than a user specific parental level granted for the user, and a transmitter configured to send a message indicating that parental control verification is required. The receiver is further configured to receive a parental control verification code in a message comprising authorization information wherein the parental control verification code is inserted instead of a password in the message, and the processor is further configured to verify the parental control verification code.

According to a fourth aspect of the present invention, a client for allowing a user of the client to get access to content protected by parental control is provided. The user has a granted user specific parental rating level is provided and the protected content is associated with a content specific parental rating level. The client comprises a transmitter configured to send a request for consuming a certain content associated with a content specific parental rating level to a content server, a receiver configured to receive a message indicating that a parental control verification code is required, input means configured to prompt the user to enter the parental control verification code and to receive the parental control verification code. Moreover, the transmitter is further configured to send the parental control verification code in a message comprising authorization information wherein the parental control verification code is inserted instead of a password in the message.

An advantage with embodiments of the present invention is that the solution is based on basic or digest access authentication which is part of the RTSP (Realtime streaming protocol), HTTP (Hypertext transfer protocol), and SIP (Session initiation protocol) messages, which is inline with the signals to be used in mobile TV.

### BRIEF DESCRIPTION OF THE DRAWINGS

The present invention will now be described in more detail by means of exemplary embodiments and with reference to the accompanying drawings, in which:

FIG. 1 is a signalling diagram illustrating the method in accordance with the present invention.

FIG. 2 is a signalling diagram illustrating a method in accordance with one embodiment of the present invention.

FIG. 3 is a block diagram illustrating a client and a content server, in accordance with embodiments of the present invention.

FIGS. 4 and 5 are flowcharts illustrating the methods according to embodiments of the present invention.

### DETAILED DESCRIPTION

Briefly described, the embodiments of the present invention provides a solution for implementing control of access to content services during the service consumption phase/period, i.e. independently of a service ordering period.

The term client will here be used for an arrangement used by a user for communicating with and/or exchange information with a content server. The client can be a mobile terminal or a set-top-box (STB).

The term content will here be used for the information provided to the user, e.g. movie or TV-show.

The term content provider is the provider, e.g. an operator providing the requested content. The content provider is the one that provides the content and the associated meta data. The server providing contents towards end users, can be controlled by the content provider or the operator. If the server is controlled by operator, the content provider needs to upload the contents towards the server.

Usually the service providers providing the parental control service are associated with the operator as they own the information of the parental rating level of end users. Thus the service provider providing the parental control service is typically the content provider described above and may therefore control the content server. Accordingly, the server managing the parental control service may be the server providing the content. It can also be contemplated that a subset of the parental control functions can be handled by the content server and another subset of the parental control functions is managed by an auxiliary server.

It is herein assumed that each content is associated with a parental rating level and a parental rating level may also be associated with a user. The association of the parental rating level of the user may be done when creating the user subscription. If the parental rating level of the content is more restrictive than the parental rating level of the user requesting the content, the user will only have access to the content in case permission is given by the parent authorized to control the user. For example,

Parental rating level 1 is set for content allowed from 5 years,
Parental rating level 2 is set for content allowed from 7 years,
Parental rating level 3 is set for content allowed from 9 years, etc.

One parental rating is set for a child by its parent, wherein the child is a user of a client. If the parental rating for the child is set to 2, then each content having a higher parental rating level than 2 has to be controlled by its parent. The functionalities associated with the parental control require two tables. One table comprises information related to the user, i.e. the parental rating level of the user, the pin code of the user and the user identity.

TABLE 1

| | | |
|---|---|---|
| User specific | pin | User id |
| Parental rating level | | |

Another table comprises information related to the content, i.e. parental rating level of the content and the content identity.

TABLE 2

| | |
|---|---|
| Content id | Content specific |
| | parental rating level |

Thus, the information of these two tables may be implemented in the content server or in an auxiliary server connected to the content server, or in a combination of both the content server and the auxiliary server.

The method of the present invention will now be described by the following example. The method is performed during the service consumption period at a content server and a client, i.e. after the service ordering period. It should be noted that the content server may also be referred to as streaming or download server.

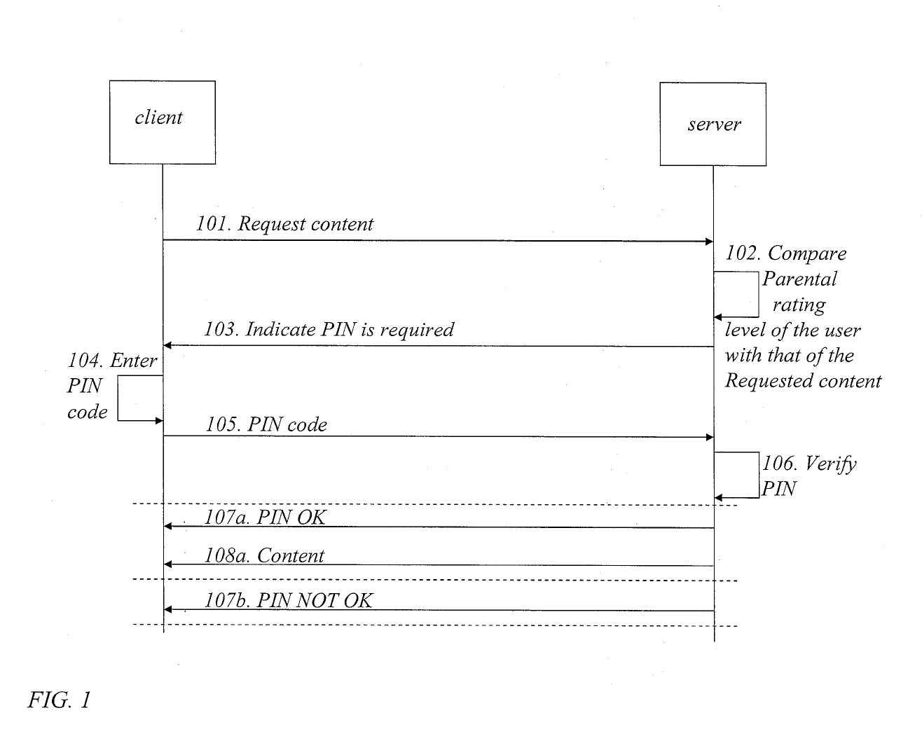

With reference to FIG. 1, illustrating a signalling chart, a procedure for performing a parental control at the content server and at a client will now be described for streamed media. However, it should be understood that the present invention is not limited to streaming, the described procedure can optionally, as is realised by a person skilled in the art, be adapted to be applied for e.g. downloading, IMS (Internet Protocol Multimedia Subsystem), etc. This procedure may for instance be implemented in mobile TV and mobile TV is typically implemented by streaming, download, or IMS-based.

The following scenario describes the streaming case.

First, a session between the client and the server is set up. During this session set up, the client is authorized. In a first step 101 shown in FIG. 1 the client requests a content which is associated with a parental rating level. The parental rating level of the content is compared 102 with the parental rating level of the user requesting the content. This comparison can either be done in the server providing the content or in an auxiliary server connected to the server providing the content. If the parental rating level of the content is not more restrictive than the parental rating level of the user, then the requested content is provided (not shown in FIG. 1). Instead if the parental rating level of the content is more restrictive than the parental rating level of the user, then the server sends 103 a message to the client which indicates that a parental control verification code such as a PIN-code is required in order to obtain the requested content.

The client is configured to interpret that a parental control verification code, here exemplified as a PIN code, is required and asks for the PIN-code from the user. The client allows accordingly the user, to enter the PIN-code. The user would typically ask the parent or another person responsible for the content consumption of the user to enter the PIN code. The parent can in this way control content consumption of the user, e.g. the child. Then the client inserts the PIN-code into a password field of a message sent to the server.

The server verifies 106 the PIN-code itself or by means of an auxiliary server. If the PIN code is correct, an ok message is sent 107a to the client and the requested content is delivered 108. If the PIN code is not correct a “not ok” message is sent 107b to the client.

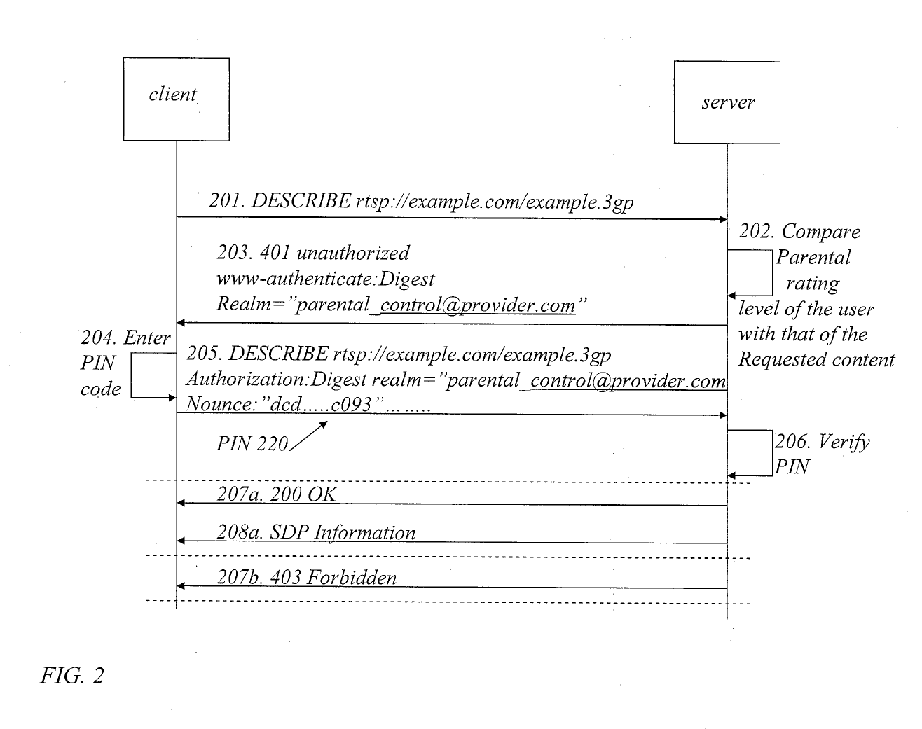

A specific embodiment of the present invention will now be described below in connection with FIG. 2. FIG. 2 describes the sequence when digest authentication is used, while the first RTSP request for the content, e.g. streamed media, is RTSP DESCRIBE, reusing an existing authentication mechanism.

In this embodiment, the message from the client to the server requesting 201 the content is an RTSP DESCRIBE message. If the server detects 202 that the parental rating level of the content is more restrictive than the level granted for the user, the server responds 203 with status code 401 Unauthorized as described in [RFC 2326] thereby initiating basic authentication or digest authentication with the input parameters listed above. Thus for each client the server stores the level granted associated with the client (and this level is possibly mapped onto several rating systems) along with one parental control verification code as shown in table 1 above.

The status code 401 unauthorized comprises a WWW-Authenticate header to the client. In the WWW-Authenticate header, basic or digest authentication can be used. According to the present invention a prefix is used to indicate for the client that a parental control verification code is required, which may be achieved by letting the realm field be “parental_control@” concatenated with some identifier for the rating level. For example, the prefix can be “parental_control@level3_provider.com”. This prefix enables a client to know the difference between the case when the 401 status code is used for requesting authentication of the user as in prior art and the case when the 401 status code is used for parental control verification according to the present invention.

When the client receives the status code 401 according to this embodiment, the client prompts 204 a dialog for the user to input a PIN code. When reusing the current authentication mechanism, the username and password fields need to be filled into. Therefore according to this embodiment, the username field is a string representation of the MSISDN and the password field is a string presentation of the parental control PIN code. For example, username=79261234567, password=020579.

For Digest Access Authentication (Chapter 3 of RFC 2617) the response from the client to the server may be calculated as indicated below. The MD5 (Message-Digest algorithm 5) is a cryptographic hash function for creating one-way hash values and the calculation of HA1 and HA2 are the steps for creating the value which is sent in the “response” field of the “Authorization” header sent from client to server, since the parental control verification code exemplified with a PIN code is not sent in clear. HA1 is also referred to as A1.

HA1=MD5(username:realm:password)
HA2=MD5(method:digestURI)
Response=MD5(HA1:nonce:HA2)

The ‘password’ field in the calculation of HA1 above is where the PIN code is inputted.

For Basic Access Authentication (Chapter 2 of RFC 2617) the base64 encoded string in the Authorization header field (e.g., “Authorization: Basic QWxhZGRpbjpvcGVulHNIc2FtZQ==”) is calculated as follows:

basic-credentials=BASE64(userid:password)

The ‘password’ field in the calculation of basic-credentials above is where the PIN code is inputted.

The PIN code can be inserted manually by the user in the password field, while the MSISDN, i.e. the username can be generated automatically by clients or manually input by end users. The user may acquire the parental control PIN code in different ways. Examples of mechanisms that can be used include post and calling to operator's customer service centre.

After that, the request e.g. the RTSP DESCRIBE message, or another RTSP request message, comprising the PIN code, will be sent 205 to the server again with Authorization header as defined in the HTTP basic and digest authentication method as described in RFC 2617

Accordingly, the server can enforce parental control of service consumption using the authentication mechanism specified in RFC 2326 for RTSP services, with the following input parameters:

Realm: “parental_control@” concatenated with a rating level identifier (e.g., “parental_control@level3_provider.com)

Username: E.g. the string representation of the MSISDN (exemplified by “79261234567”)

Password: The string representation of the parental control PINCODE (e.g., “020579”) When receiving the RTSP DESCRIBE message or another RTSP request with the PIN code the server will check 206 whether the user has submitted the correct PIN code. If the PIN code check is succeeded, the server would respond 207a 200 OK and provide 208a the content. Otherwise, 403 Forbidden 207b would indicate the authorization failure.

According to a further embodiment of the present invention, the message from the content server to the client indicating that a parental control verification code is required is a “PIN Code Required”-message with a new error code. It should be noted that this message is a new message compared to the 401 unauthorized message which exists in existing authorization methods. When the client receives the request of the parental control verification code, e.g. a PIN code, the client would prompt the end user to input the PIN code, e.g. by a dialog window as in the first embodiment. The PIN code would then be provided from the parent of the user. The parent may have got access to the PIN code from the service provider in way hidden from the user of the client, e.g. the child. The PIN code is inserted in the response field in the authorization field, as exemplified in conjunction with the above described embodiment in conjunction with FIG. 2.

Unlike basic and digest authentication, in the PIN code context, there is no need to have the user name and password in the response message from the client to the server when providing the PIN code. Instead, the password is replaced by the PIN code by replacing the password field with a PIN code field.

So, basic authentication for PIN code check needs to contain the value defined as below:

Basic-credentials=base64-pin
base64-pin=base64 encoding of PIN code

In the further embodiment, the digest authentication for the PIN code does not need to include user name and password. So, the definition for A1 can be changed as below if the algorithm is MD5 or unspecified, which is further described in RFC 2617.

A1=unq(realm-value)“:”pincode
If the algorithm is MD5-sess, the A1 can be changed as below:
A1=H(unq(realm-value_)“:”pincode)“:”unq(nonce-value)“:”unq(cnonce-value)

Hence, when the server receives this request e.g. in the RTSP DESCRIBE message, the server will check whether the end user has submitted the correct PIN code. If the PIN code check succeeded, server would respond 200 OK. Otherwise, a message with a new error code, e.g. 419 PIN Code Required or 403 Forbidden would indicate the authorization failure, which might trigger another PIN Code check transaction.

In these exemplary embodiments a PIN code is used to make sure that the user of the client is allowed to consume the content. However, any other suitable code, number, sequence, etc. may also be used in the manner described to make sure that the user of the client is allowed to consume the content.

In the above described embodiments, the content to be streamed is requested from a streaming server. However, a similar function may be introduced for download and IMS-based mobile TV implementations. A mobile TV implementation implies an implementation of a mobile TV service which is based on a streaming protocol such as RTSP/RTP where the media is sent in the same rate as it is consumed. This can be compared to a download implementation which typically means that the user downloads the file using HTTP and then stores the file. IMS based mobile TV implementations are specified in 3GPP TS 26.237 “IP Multimedia Subsystem (IMS) based Packet Switch Streaming (PSS) and Multimedia Broadcast/Multicast Service (MBMS) User Service”. It specifies a way to use IMS to initiate and control PSS and MBMS User Service. In short, it uses the IMS method for session management (SIP INVITE), while RTSP method (RTSP PLAY) is used to trigger streaming playback as described below.

In the download case, HTTP (Hypertext transfer protocol) is used for carrying the authorization information. For the download case, there is no specific signalling and session management. The client sends a HTTP GET to request the content, e.g. a video clip. The server returns the content in a HTTP GET response. The client is able to play the video clip locally after finishing the download. It should be noted, that for progressive download, it is possible to play while downloading the specific encoded contents. Therefore, for the download case the authorization step will always be performed in HTTP GET request as further described below.

1. When receiving HTTP GET request in the download case and SIP INVITE request in the IMS-based case, the server authenticates the user and compares if the parental rating level of the content is more restrictive than the level granted for the user.
2. If the parental rating level of the content is more restrictive than the parental level of the user, the server would respond with a PIN Code Required with a new error code or a 401 unauthorized with WWW-Authenticate header indicating whether basic or digest authentication is used, together with other information like the realm as described above.
3. The client prompts a user dialog for the parent of the user to input the PIN code.
4. After receiving the PIN code, the client sends the request again with Authorization header with the basic or digest authentication information. As the method described above, if 401 Unauthorized is used as the response code, to align with the current implementation, the password field can be used for the PIN code. If a new response code is introduced to indicate that PIN code is needed, the password field can be replaced by a PIN code field.
5. The server verifies the PIN code from the request. If the PIN code check succeeds, 200 OK will be responded. Otherwise, 403 Forbidden will be sent.

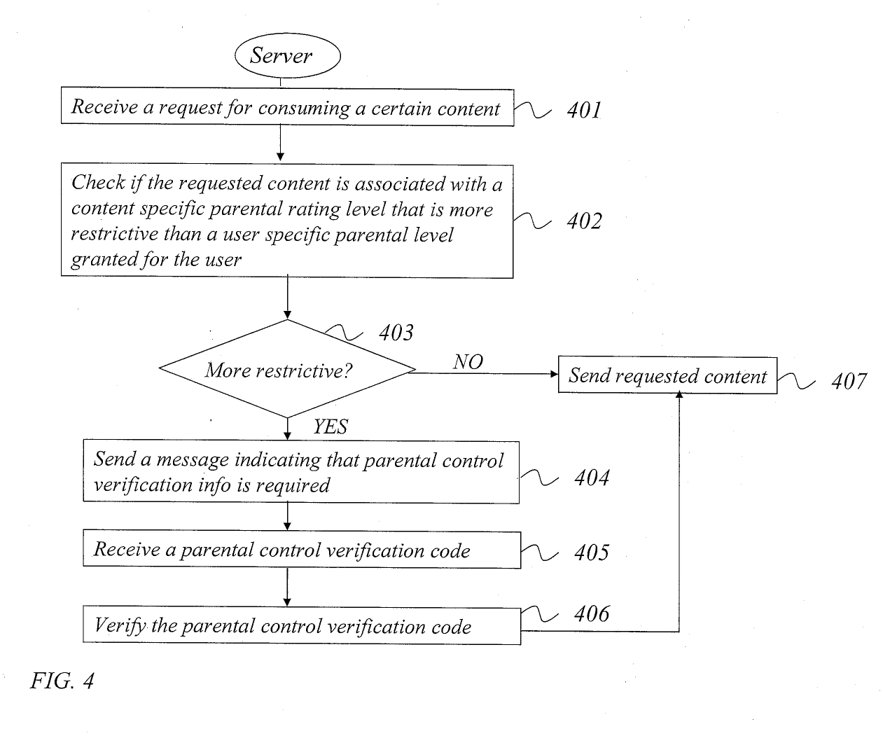

According to one aspect of the present invention a method in a server, e.g. a streaming server, is provided. The server controls the content to be consumed by a user having a granted user specific parental rating level and the controlled content is associated with a content specific parental rating level. As illustrated in FIG. 4, a request for consuming a certain content associated with a content specific parental rating level from a client used by a user is received 401. The server then checks 402 if the requested content is associated with a content specific parental rating level that is more restrictive than a user specific parental level granted for the user. If 403 the requested content is associated with a content specific parental rating level that is less restrictive than the user specific parental level granted for the user, the requested content is delivered. In the other case when 403 the requested content is associated with a content specific parental rating level that is more restrictive than the user specific parental level granted for the user then a message indicating that a parental control verification code is required is sent 404 and the parental control verification code is received 405 in a message comprising authorization information wherein the parental control verification code is inserted instead of a password in the message. Finally the received parental control verification code is verified 406.

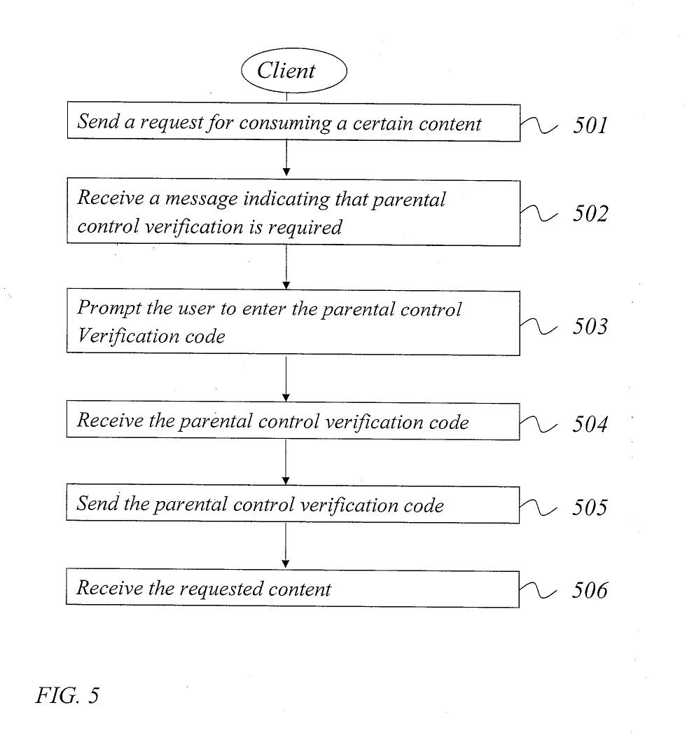

According to another aspect of the present invention a method in a client, e.g. a mobile terminal or a set top box, is provided. As illustrated in FIG. 5, the client sends 501 a request for consuming a certain content associated with a content specific parental rating level to a content server. If the requested content is associated with a content specific parental rating level that is more restrictive than a user specific parental level granted for the user, the client receives 502 a message indicating that parental control verification is required. Subsequently, the client prompts 503 the user to enter the parental control verification code such as a PIN code. When the client has received 504 the parental control verification code from the parent of the user of the client, the client sends 505 the parental control verification code in a message comprising authorization information wherein the parental control verification code is inserted instead of a password in the message. If the inserted code is correct, the client will be provided 506 with the requested content.

The message indicating that parental control is required and the received parental control verification code in the message may be constructed according to basic or digest authentication.

According to one embodiment in the streaming and the IMS scenario, the request for consuming a certain content and the message wherein the parental control verification code is received are RTSP messages e.g. RTSP DESCRIBE or RTSP SETUP messages. In the download scenario, the request for consuming a certain content and the message wherein the parental control verification code is received may be HTTP messages such as HTTP GET or HTTP POST messages.

As further explained above, the message indicating that verification is required may be an existing 401 unauthorized message by using in the message a prefix in the realm to indicate that a parental control verification is required. As an alternative a new message referred to as a PIN code required message with a new status code may be created to indicate that the parental control verification exemplified as a PIN code is required.

The methods described above may be implemented in a server and a client, respectively.

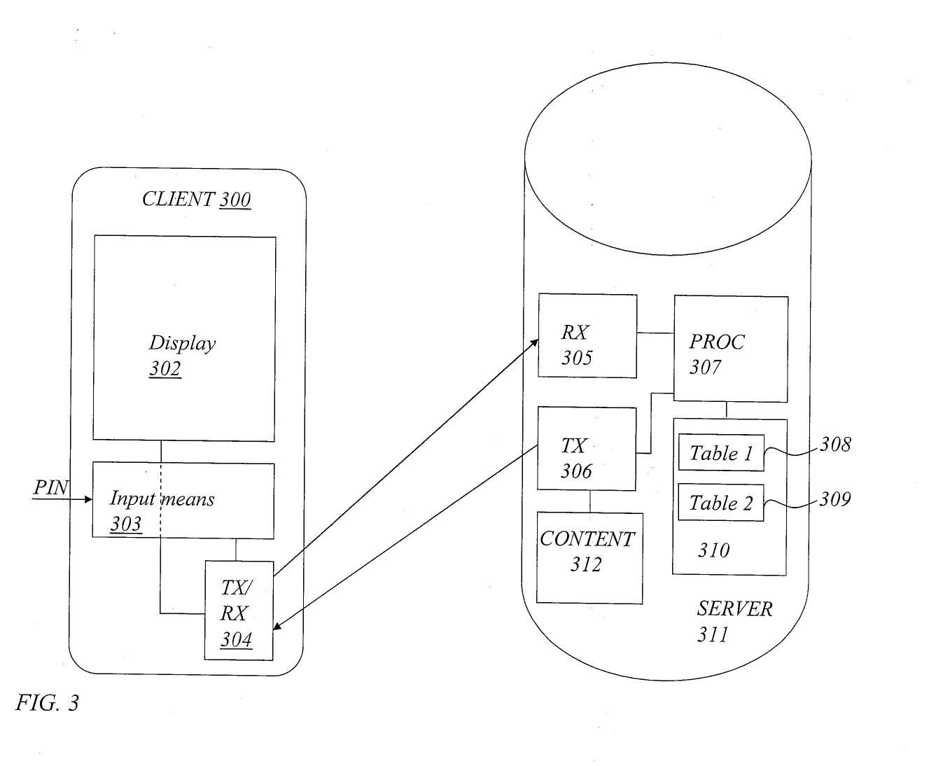

The client and the server are illustrated in FIG. 3. The server 311 controls the content to be consumed by a user having a granted user specific parental rating level and the controlled content is associated with a content specific parental rating level. According to an embodiment of the present invention, the server comprises a receiver 305 and transmitter 306 for receiving and transmitting information from/to the client. The server may further comprise a memory storing tables referred to as table 1 308 and table 2 309 of the user specific parental rating level and the content specific rating level. In addition the server also typically stores the content 312 to be provided to the user and a processor 307 for processing the information relating to the parental control. It should however be noted that the functionality relating to the parental control may be distributed to an auxiliary server, partly or entirely. Also, the content requested by the client may also be stored in another server. Thus the receiver 305 is configured to receive a request for consuming a certain content associated with a content specific parental rating level from a client used by a user. The processor 307 is configured to check if the requested content is associated with a content specific parental rating level that is more restrictive than a user specific parental level granted for the user and the transmitter 306 is configured to send a message indicating that parental control verification is required. Moreover, the receiver 305 is further configured to receive a parental control verification code in a message wherein the parental control verification code is inserted in a password field of the message. The processor 307 is further configured to verify the parental control verification code, and the transmitter 306 can provide the requested content to the user.

According to embodiments of the present invention, the receiver 305 is configured to receive the request for consuming a certain content and the message wherein the parental control verification information is received as RTSP DESCRIBE messages or as HTTP GET messages as exemplified above. Also, the receiver may be configured to send the message indicating that verification is required as a 401 unauthorized message by using in the message a prefix in the realm to indicate that a parental control verification code is required. As an alternative, a PIN code required message with a new status code can be created for this purpose.

Turning again to FIG. 3 also illustrating a client. The client 300 comprises a transmitter 304 and a receiver 304 for communicating with the server. The client also comprises input means 303 for prompting the user to generate the PIN code and for receiving the PIN code, i.e. the parental control verification, e.g. a keyboard or touch screen. The client typically also comprises a display and speaker for consuming requested contents such as video clips. The transmitter 304 is configured to send a request for consuming a certain content associated with a content specific parental rating level to a content server and the receiver 304 is configured to receive a message indicating that a parental control verification code is required. The transmitter is further configured to send the parental control verification code in a message wherein the parental control verification code is inserted in a password field of the message. As explained above, the parental verification code exemplified by the PIN code 220 (FIG. 2) may not be inserted in clear in the message.

According to embodiments of the present invention, the receiver 304 is configured to send the request for consuming a certain content and the message wherein the parental control verification code are sent as RTSP messages when streaming content is requested. In the case of downloading, said messages may be sent as HTTP messages.

Furthermore, it is to be understood that the content server, and the client described above in this description also comprises additional conventional means providing functionality, such as e.g. various control units and memories, necessary for enabling common functions and features to operate properly. However, for simplicity reasons, any means or functionality which is not necessary for the understanding of the proposed enabling of limiting control service has been omitted in the figures, and will not be discussed in any further detail in this description.

Although procedures and communications network nodes for parental control of children's use of Mobile TV services are described in the exemplary embodiments above, the invention is not limited thereto. The described procedures and network nodes can optionally, as is realised by one skilled in the art, be adapted to be applied to any suitable controlling of any users access to a restricted service provided by a server.

1. A method in a server for controlling content to be consumed by a user, the method comprising:
receiving from a client of a user a request to consume a certain content, the user having a user-specific parental rating level and the content having a content-specific parental rating level;
checking if the content-specific parental rating level of the requested content is more restrictive than the user-specific parental rating level of the user;
if the content-specific parental rating level is more restrictive:
sending a first message indicating that a parental control verification code is required,
receiving a parental control verification code in a second message comprising authorization information wherein the parental control verification code is inserted instead of a password in the second message, and
verifying the parental control verification code.

2. The method according to claim 1, wherein the first and second messages are constructed according to basic authentication.

3. The method according to claim 1, wherein the first and second messages are constructed according to digest authentication.

4. The method according to claim 1, wherein the request and the second message are RTSP messages.

5. The method according to claim 1, wherein the request and the second message are HTTP messages.

6. The method according to claim 1, wherein the first message is a 401 unauthorized message that has a prefix in the realm indicating that a parental control verification code is required.

7. The method according to claim 1, wherein the first message is a “PIN code required” message with a status code selected to indicate that a parental control verification code is required.

8. A method in a client for allowing a user of the client to get access to content protected by parental control, the method comprising:
sending to a content server a request for consuming a certain content that has a content-specific parental rating level,
if the content-specific parental rating level is more restrictive than a user-specific parental level of the user:
receiving a first message indicating that a parental control verification code is required;
prompting the user to enter the parental control Verification code;
receiving the parental control verification code; and
sending the parental control verification code in a second message comprising authorization information wherein the parental control verification code is inserted instead of a password in the second message.

9. The method according to claim 8, wherein the first and second messages are constructed according to basic authentication.

10. The method according to claim 8, wherein the first and second messages are constructed according to digest authentication.

11. The method according to claim 8, wherein the request and the second message are RTSP messages.

12. The method according to claim 8, wherein the request and the second message are HTTP messages.

13. The method according to claim 8, wherein the first message is a 401 unauthorized message that has a prefix in the realm indicating that a parental control verification code is required.

14. The method according to claim 8, wherein the first message is a “PIN code required” message with a status code selected to indicate that a parental control verification code is required.

15. A server for controlling content to be consumed by a user, the server comprising:
a receiver configured to receive from a client of a user a request for consuming a certain content, the user having a user-specific parental rating level and the content having a content-specific parental rating level,
a processor configured to check if the content-specific parental rating level of the requested content is more restrictive than the user-specific parental level of the user,
a transmitter configured to send a first message indicating that parental control verification is required;
wherein the receiver is further configured to receive a parental control verification code in a second message comprising authorization information wherein the parental control verification code is inserted instead of a password in the second message, and
wherein the processor is further configured to verify the parental control verification code.

16. The server according to claim 15, wherein the receiver is configured to receive the request and the second message as RTSP messages.

17. The server according to claim 15, wherein the receiver is configured to receive the request and the second message as HTTP messages.

18. The server according to claim 15, wherein the transmitter is configured to send the first message as a 401 unauthorized message that has a prefix in the realm indicating that a parental control verification code is required.

19. The server according to claim 15, wherein the transmitter is configured to send the first message as a “PIN code required” message with a status code selected to indicate that a parental control verification code is required.

20. A client configured to allow a user of the client to get access to content protected by parental control, the client comprising:
a transmitter configured to send to a content server a request for consuming a certain content having a content-specific parental rating level;
a receiver configured to receive, if the content-specific parental rating level is more restrictive than a user-specific parental rating level of the user, a first message indicating that a parental control verification code is required;
a user interface configured to prompt the user to enter the parental control verification code and to receive the parental control verification code; and
wherein the transmitter is further configured to send the parental control verification code in a second message comprising authorization information wherein the parental control verification code is inserted instead of a password in the second message.

21. The client according to claim 20, wherein the transmitter is configured to send the request, and the receiver is configured to receive the first message, as RTSP messages.

22. The client according to claim 20, wherein the transmitter is configured to send the request, and the receiver is configured to receive the first message, as HTTP messages.

23. The client according to claim 20, wherein the first message is a 401 unauthorized message that has a prefix in the realm indicating that a parental control verification code is required.

24. The client according to claim 20, wherein the first message is a “PIN code required” message with a status code selected to indicate that a parental control verification code is required.
